(19) United States
(12) Patent Application Publication
(10) Pub. No.: US 2025/0286982 A1
(43) Pub. Date: Sep. 11, 2025

(54) IMAGE PROJECTION SYSTEM

(71) Applicants: Mayu Banno, KANAGAWA (JP); Toshiharu Hachisuka, KANAGAWA (JP); Kazuhiro Fujita, TOKYO (JP)

(72) Inventors: Mayu Banno, KANAGAWA (JP); Toshiharu Hachisuka, KANAGAWA (JP); Kazuhiro Fujita, TOKYO (JP)

(73) Assignee: Ricoh Company, Ltd., Tokyo (JP)

(21) Appl. No.: 19/062,502

(22) Filed: Feb. 25, 2025

(30) Foreign Application Priority Data
Mar. 5, 2024 (JP) 2024-033104

(51) Int. Cl. H04N 9/31; G02B 27/01

(52) U.S. Cl. CPC H04N 9/3182; G02B 27/0172; G02B 2027/014

(57) ABSTRACT

An image projection system includes a light source to emit light, an image display element to modulate the light emitted from the light source to display an image based on an input image, a projection optical system to project the image displayed by the image display element, and a control unit to invert gradation of at least a partial region of the input image based on a command information generated when a predetermined condition is satisfied.

### CROSS-REFERENCE TO RELATED APPLICATIONS

This patent application is based on and claims priority pursuant to 35 U.S.C. § 119 (a) to Japanese Patent Application No. 2024-033104, filed on Mar. 5, 2024, in the Japan Patent Office, the entire disclosure of which is hereby incorporated by reference herein.

### BACKGROUND

The present disclosure relates to an image projection system.

### RELATED ART

An image projection system such as a projector that projects a monochromatic image is known.

In order to prevent the gradation of an auxiliary image to be confirmed by an operator of the image projection system at hand from being inverted with respect to the main projection image, a configuration in which a light modulation device is operated based on an image signal corresponding to the inverted image when the auxiliary image is projected has been proposed in the related art.

### SUMMARY

According to an embodiment of the present disclosure, an image projection system includes a light source to emit light, an image display element to modulate the light emitted from the light source to display an image based on an input image, a projection optical system to project the image displayed by the image display element, and a control unit to invert gradation of at least a partial region of the input image based on a command information generated when a predetermined condition is satisfied.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image projection system according to a first embodiment of the present disclosure and a peripheral system;

FIG. 2 is a schematic diagram illustrating a light source included in an image projection system according to the first embodiment of the present disclosure;

FIG. 3 is a schematic plan view of a configuration of a phosphor wheel included in the light source in FIG. 2 as viewed from a direction in a rotation shaft of the phosphor wheel;

FIG. 4 is a schematic cross-sectional view of a configuration of the phosphor wheel included in the light source in FIG. 2 as viewed from a direction intersecting a rotation shaft of the phosphor wheel;

FIG. 5 is a graph of a spectral distribution of light emitted from the phosphor wheel included in the light source in FIG. 2;

FIG. 6 is a graph of a ratio of an emission intensity of yellow fluorescent light having wavelengths of 510 nm or greater and 610 nm or smaller in a wavelength range of light emitted from an image projection system according to the first embodiment of the present disclosure;

FIG. 7 is a graph of a ratio of an emission intensity of yellow fluorescent light having wavelengths of 428 nm or greater and 688 nm or smaller in a wavelength range of light emitted from an image projection system according to the first embodiment of the present disclosure;

FIG. 8 is a schematic diagram illustrating a configuration of a projection optical system included in an image projection system according to the first embodiment of the present disclosure;

FIG. 9 is a timing chart of a gradation generation method in a typical color-image projection system;

FIG. 10 is a timing chart of a gradation generation method in an image projection system according to the first embodiment of the present disclosure;

FIG. 11 is a flowchart of gradation inversion processing in an image projection system according to the first embodiment of the present disclosure;

FIG. 12 is a diagram illustrating an image processing result and a projection image in an image projection system according to the first embodiment of the present disclosure;

FIG. 13 is a diagram illustrating an overall configuration of an image projection system according to a second embodiment of the present disclosure;

FIG. 14 is a diagram illustrating an overall configuration of an image projection system according to a third embodiment of the present disclosure;

FIG. 15 is a flowchart of gradation inversion processing in an image projection system according to a fourth embodiment of the present disclosure;

FIG. 16A is a schematic perspective view of a configuration of a wearable display apparatus that is a projection apparatus according to an application example;

FIG. 16B is a schematic diagram illustrating an example of a partial configuration of a wearable display apparatus according to an application example;

FIGS. 16C and 16D are schematic diagrams illustrating other examples of a configuration of a wearable display apparatus according to an application example;

FIG. 16E is a schematic diagram illustrating a helmet-shaped apparatus including a visor including a light guide plate in a wearable display apparatus according to an application example;

FIGS. 16F and 16G are schematic diagrams illustrating an example of a configuration of a wearable display apparatus according to an application example;

FIG. 17A is a schematic diagram illustrating an example of an automobile including a head-up display apparatus as an example of a projection apparatus according to an application example;

FIG. 17B is a schematic diagram illustrating an example of a head-up display apparatus according to an application example; and

FIG. 17C is a schematic diagram illustrating an example of another configuration of a head-up display apparatus according to an application example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Advantageous Effect of Invention

According to the present disclosure, an easily viewable projection image can be provided.

An image projection system according to an embodiment of the present disclosure will be described in detail with reference to the drawings. The embodiments described below are examples of apparatuses for embodying the technical idea of the disclosure, and the present disclosure is not limited to the embodiments described below.

Unless otherwise specified, shapes of components, relative arrangements thereof, and values of parameters described below are not intended to limit the scope of the present disclosure but are intended to exemplify the scope of the present disclosure. The relative positions or the size of the elements illustrated in the drawings may be exaggerated for purpose of clear description. In the following description, common or corresponding elements are denoted by the same or similar reference signs, and redundant description is appropriately simplified or omitted.

### First Embodiment

### Configuration of Image Projection System According to First Embodiment

### Overall Configuration

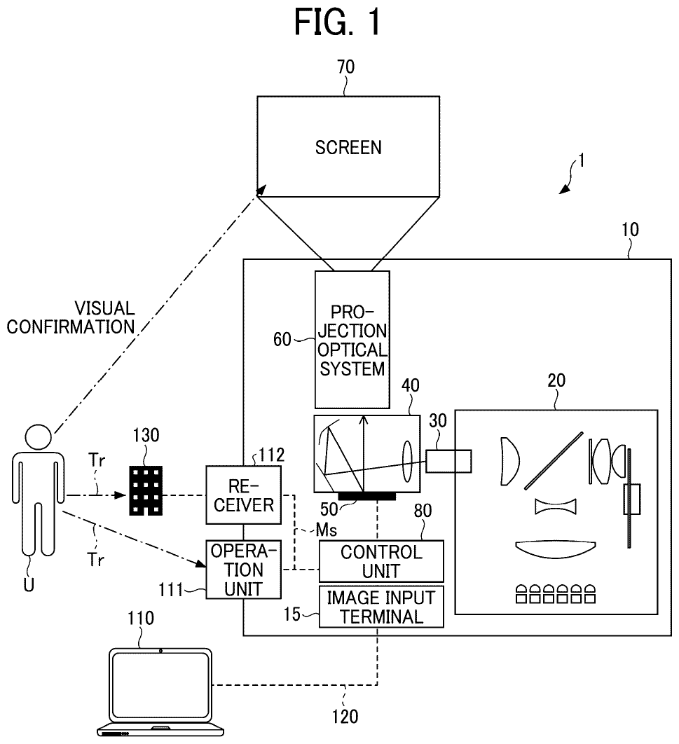

FIG. 1 is a schematic diagram illustrating an image projection system 1 according to a first embodiment of the present disclosure and a peripheral system. In FIG. 1, the inside of the image projection system 1 is illustrated as a perspective view.

The image projection system 1 includes a light source 20, an image display element 50 to modulate light emitted from the light source 20 to display an image based on an input image, and a projection optical system 60 to project the image displayed by the image display element 50. The image projection system 1 further includes a control unit 80 that inverts the gradation of at least a partial region of the input image in response to a receipt of command information generated when a predetermined condition is satisfied. The command information Ms is information on a command that inverts the gradation of at least a partial region of the input image. The projection optical system 1 magnifies and projects the image displayed on the image display element 50 on a screen 70 by the projection optical system 60. In the first embodiment of the present disclosure, when there is an operation input Tr by an operator U, the gradation of at least a partial region of the input image is inverted.

In recent years, there have been some applications of image projection systems in which brightness is more prioritized than the width of color gamut, such as guide display and drawing projection. In such applications, a monochrome image (i.e., monochromatic image) using a monochromatic color with high visibility can also achieve the purpose.

However, for example, in the case of a monochromatic projector that projects only yellow light with high visibility, a color image becomes a monochrome image when it is projected with yellow light. When the monochrome image is projected on the screen as it is, the originally white region of the projection image on the screen becomes yellow, and the gray region becomes yellow with lower illuminance than the white region. As a result, the projection image becomes a monochrome image with yellow shading as a whole, and the image becomes an image in which characters and figures are very difficult to read.

In contrast, when a monochrome image is inverted in the gradation and projected as a gradation-inverted image, a black region in the input image is not irradiated with the yellow light, and the yellow light is projected on only a gray region. As a result, a projection image in which characters and figures are more easily viewable than a projection image before gradation inversion can be provided. In other words, a region that becomes a background of the input image is represented by a “black” signal that does not irradiate the region with the light so that a projection image becomes easily viewable and recognizable. The term “gradation inversion” is equivalent to inversion of color. In the gradation inversion, for example, white is inverted to black and black is inverted to white. In the gradation inversion in the case of the three primary colors of red (R), green (G), and blue (B), for example, red is inverted to cyan, green is inverted to magenta, and blue is inverted to yellow.

Further, the gray region in the image after the gradation inversion is converted into a white region so that the illuminance of yellow light for displaying characters and figures can be increased. Since the difference in illuminance between the background that is a non-irradiation region and the characters and figures that are irradiation regions is increased, the characters and figures are more easily readable.

By contrast, for example, when the input image has a background of black, the characters and figures are hard to view by performing the gradation inversion. Thus, a specification that inverts the gradation in all cases may not be appropriate. In addition, a wide region is irradiated with yellow light in the dark place so that it is convenient for an operator that traces a projection image displaying figures with a pen because of brightness at hand of the operator.

In the image projection system 1 according to the first embodiment of the present disclosure, the gradation of at least a partial region of the input image is inverted in a response to a receipt of command information Ms generated when a predetermined condition is satisfied. The image projection system 1 inverts the gradation in accordance with the command information Ms so that the difficulty in viewing the projection image is eliminated and the projection image becomes easily viewable. In the present embodiment, examples of the predetermined condition include a case where the operation input Tr is input by an operator, a case where the image average luminance of the input image is higher than a predetermined image average luminance threshold, and a case where the average value of the luminance calculated based on the color information of each pixel of the input image is higher than the predetermined luminance. The predetermined conditions are not limited to the cases described above, and other conditions may be set as the predetermined conditions.

In the image projection system 1 illustrated in FIG. 1, the control unit 80 determines whether to start processing for inverting the gradation of at least a partial region of the input image in accordance with the operation input Tr by the operator U, and inverts the gradation of at least a partial region of the input image in accordance with the determination result. For example, when the operation input Tr is input by the operator U, the operation input Tr becomes the command information Ms, and the control unit 80 inverts the gradation of at least a partial region of the input image using the command information Ms as a trigger.

Accordingly, when the image projected on the screen 70 is not easily viewable for the operator U, the gradation of at least a partial region of the input image can be inverted. As a result, the projection image becomes an easily viewable image.

In the image projection system 1 illustrated in FIG. 1, the input image is a color image, and the control unit 80 performs monochrome processing on the input image. When the control unit 80 performs monochrome processing on a color image, a projection image in which characters and figures are difficult to read is likely to be obtained. In the image projection system 1, the gradation of at least a partial region of the input image is inverted so that the projection image becomes easily viewable even when the control unit 80 performs monochrome processing on a color image.

In the image projection system 1, light emitted from the light source 20 satisfies the relations of A>B and A>C, where A is the radiation energy of light having a wavelength of 510 nm or greater to 610 nm or smaller (i.e., first light), B is the radiation energy of light having a wavelength smaller than 510 nm (i.e., second light), and C is the radiation energy of light having a wavelength greater than 610 nm (i.e., third light). The image projected by the projection optical system 60 also satisfies A>B and A>C. When monochromatic light having a wavelength of 510 nm or greater and 610 nm or smaller is used, a projection image in which characters and figures are difficult to read is likely to be obtained. In the image projection system 1, even when the light emitted from the light source 20 is monochromatic light having a wavelength of 510 nm or greater and 610 nm or smaller and also the image projected by the projection optical system 60 is a monochromatic image, the projection image becomes easily viewable by inverting the gradation of at least a partial region of the input image.

The light emitted from the light source 20 can also emit light satisfying A>B+C. In this case, the gradation of at least a partial region of the input image is inverted so that the projection image becomes easily viewable.

The image projection system 1 illustrated in FIG. 1 includes a housing 10, a light uniformizing element 30, and an illumination optical system 40. The housing 10 accommodates the light source 20, the light uniformizing element 30, the illumination optical system 40, the image display element 50, and the projection optical system 60 in its inside. The light uniformizing element 30 uniformizes the light emitted from the light source 20 by mixing the light intensity of the light. The light uniformizing element 30 includes, for example, a light tunnel formed by combining four mirrors, a glass rod, a microlens array, and a diffusion plate. The illumination optical system 40 illuminates the image display element 50 with the light substantially uniformized by the light uniformizing element 30. The illumination optical system 40 includes, for example, one or more lenses or one or more reflection surfaces. The image display element 50 includes, for example, a light valve such as a digital micromirror device (DMD), a transmissive liquid crystal panel, and a reflective liquid crystal panel. The image display element 50 is irradiated with the light (from the light source optical system of the light source 20) through the illumination optical system 40 and modulates the light to display an image. The projection optical system 60 magnifies and projects the image displayed on the image display element 50 on the screen 70. The projection optical system 60 includes, for example, one or more lenses.

The image projection system 1 and a video supply device 110 are connected by a cable 120. The video supply device 110 supplies a video signal corresponding to an input image to the image projection system 1 through the cable 120. The video signal includes an image signal for displaying a still image. The image projection system 1 generates an image based on an input image supplied by the video supply device 110, and projects the image on a projection surface such as a screen 70.

The image projection system 1 includes a high-definition multimedia interface (HDMI, registered trademark), a DisplayPort terminal, a Thunderbolt terminal, a video graphics array (VGA) input terminal, an S-VIDEO terminal, and an RCA terminal as terminals for inputting a video signal. The image projection system 1 preferably includes multiple video input terminals. The image projection system 1 receives a video signal from the video supply device 110 through the cable 120 connected to a video input terminal. The cable 120 is, for example, an HDMI cable.

The image projection system 1 may receive a video signal from the video supply device 110 by wireless communication conforming to a wireless communication protocol such as Bluetooth (registered trademark) or Wi-Fi (registered trademark).

The video supply device 110 is an apparatus for supplying an image to be projected by the image projection system 1. The video supplying device 110 includes an interface for outputting a video signal, and transmits a video signal that forms a display image of the video supplying device 110 to the image projection system 1 at a predetermined transfer rate (e.g., 30 frames per second (fps) or more and 60 fps or less).

The video supply device 110 also includes an HDMI terminal, a DisplayPort terminal, a Thunderbolt terminal, a VGA input terminal, an S-VIDEO terminal, and an RCA terminal as interfaces that output a video signal. The video supply device 110 can transmit a video signal to the image projection system 1 through the cables 120 connected to these terminals. The video supply device 110 may transmit a video signal to the image projection system 1 through wireless communication.

As the video supply device 110, for example, an information processing apparatus that can supply a video signal, such as a laptop personal computer (PC), a desktop PC, a tablet PC, a smartphone, or a personal digital assistant (PDA) can be used, or a reproduction apparatus, such as a digital versatile disc (DVD) player or a Blu-ray player, can be used. In the example illustrated in FIG. 1, one video supply device 110 is connected to the image projection system 1, but multiple video supply devices 110 may be connected to the image projection system 1.

The operation unit 111 receives various operation inputs Tr from an operator such as a user of the image projection system 1, and implements functions corresponding to the operation inputs Tr through the control unit 80. The operation unit 111 can receive operation inputs Tr from, for example, cursor keys, character keys, numeral keys, and various function keys. The operation unit 111 outputs the command information Ms corresponding to the operation input Tr to the control unit 80 in accordance with the operation input Tr.

A receiver 112 receives various operation inputs Tr from a remote location through, for example, an infrared remote control 130 (directional one-way communication) and implements functions corresponding to the operation inputs Tr through the control unit 80. The receiver 112 can receive operation inputs Tr from cursor keys, character keys, numeral keys, and operation inputs Tr of various functions through, for example, the infrared remote control 130. The receiver 112 outputs the command information Ms corresponding to the operation input Tr to the control unit 80 in accordance with the operation input Tr.

The control unit 80 implements functions such as system control, image processing, optical device control, light source control, power supply control, cooling fan control, recording, and display. The control unit 80 includes electronic boards The electronic boards included in the control unit 80 may be integrated as one body, or multiple electronic boards are connected by wiring or connectors.

### Light Source

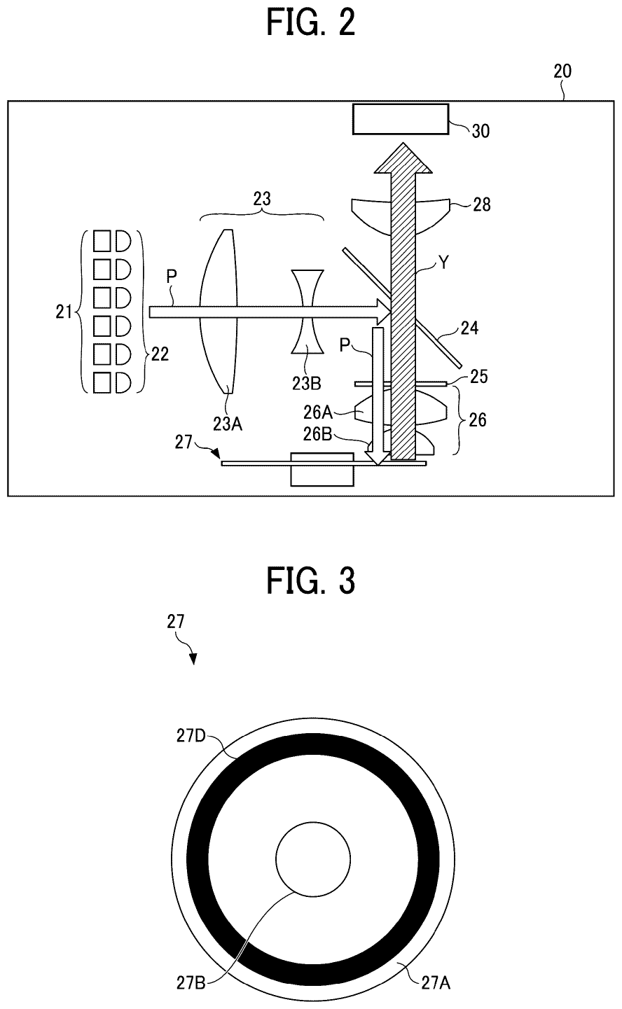

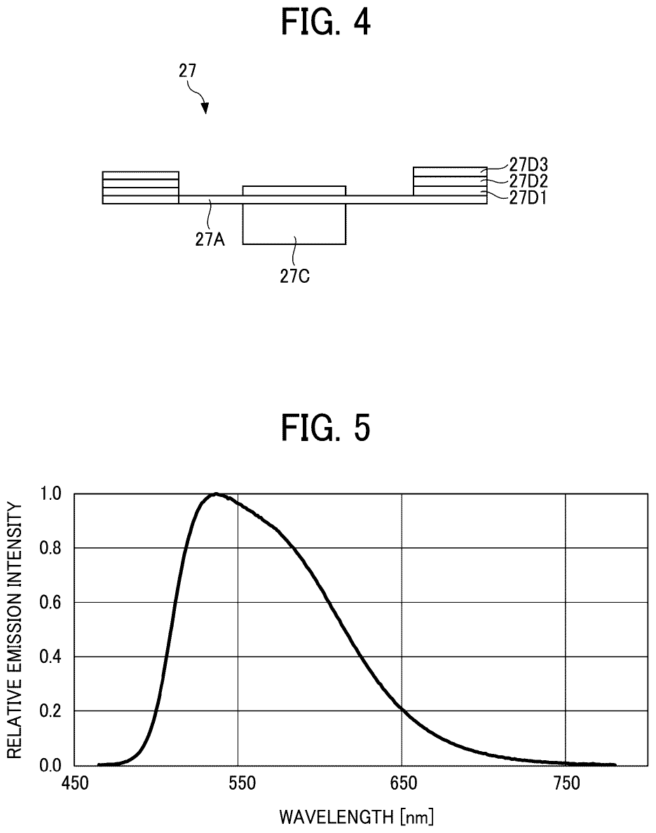

The configuration of the light source 20 included in the image projection system 1 according to the first embodiment of the present disclosure will be described with reference to FIGS. 2 to 5. FIG. 2 is a schematic diagram illustrating the light source 20 included in the image projection system 1 according to the first embodiment of the present disclosure. FIG. 3 is a schematic plan view of a configuration of a phosphor wheel 27 included in the light source 20 in FIG. 2 as viewed from a direction along a rotation shaft of the phosphor wheel 27. FIG. 4 is a schematic cross-sectional view of a configuration of a phosphor wheel 27 included in the light source 20 in FIG. 2 as viewed from a direction intersecting a rotation shaft of the phosphor wheel 27. FIG. 5 is a graph of a spectral distribution of the light emitted from a phosphor wheel 27 included in the light source 20 in FIG. 2.

The light source 20 includes an excitation light source 21 and a phosphor wheel 27 in which the light emitted from the excitation light source 21 goes and that emits the light having a wavelength different from the wavelength of the light emitted from the excitation light source 21. In an example illustrated in FIG. 2, the light source 20 includes collimator lenses 22, a first optical system 23, a polarizing beam splitter 24, a quarter-wave plate 25 (¼ wavelength plate), a second optical system 26, and a condenser lens 28. The excitation light source 21, the collimator lenses 22, the first optical system 23, the polarizing beam splitter 24, the quarter-wave plate 25, the second optical system 26, the phosphor wheel 27, and the condenser lens 28 are arranged in this order in the light propagation direction. For example, the “light source optical system” includes the components other than the excitation light source 21 in the light source 20. The first optical system 23 includes a first lens 23A and a second lens 23B. The second optical system 26 includes a third lens 26A and a fourth lens 26B.

The excitation light source 21 includes multiple semiconductor lasers as multiple solid light sources. Multiple solid light sources are used as the excitation light source 21 so that the light extraction efficiency from the light source 20 can be increased while the light source 20 reduces its size. In the excitation light source 21 illustrated in FIG. 2, six semiconductor lasers are arranged in four rows in the depth direction. In a virtual plane intersecting the light emission direction from the excitation light source 21, 6×4=24 semiconductor lasers are two dimensionally aligned. Each of the multiple semiconductor lasers included in the excitation light source 21 emits, for example, light in a blue band (i.e., a blue laser light) having the center wavelength of emission intensity of 455 nanometers (nm) as an excitation light P that excites the phosphor (or fluorescent) material disposed in a phosphor region 27D of the phosphor wheel 27.

The excitation light P emitted from each of the multiple semiconductor lasers included in the excitation light source 21 is linearly polarized light having a constant polarization state and is coherent light. The multiple semiconductor lasers included in the excitation light source 21 are disposed so as to emit S-polarized light with respect to the incident surface of the polarizing beam splitter 24. The excitation light P emitted from each light source of the excitation light source 21 may be any light having a wavelength that can excite the phosphor material in the phosphor region 27D of the phosphor wheel 27, and is not limited to light in a blue band. The number of light sources of the excitation light source 21 is not limited to 24, and may be 1 or more and 23 or less, or may be 25 or more. The excitation light source 21 can be configured as, for example, a light source array in which multiple light sources are arranged in an array on a board, and the specific aspect of the excitation light source 21 has a degree of freedom.

The collimator lenses 22 includes, for example, 24 collimator lenses corresponding to the 24 light sources of the excitation light source 21. Each collimator lens 22 adjusts the excitation light P emitted from each light source of the excitation light source 21 so as to be substantially parallel light. The number of collimator lenses 22 may correspond to the number of light sources of the excitation light source 21, and may be increased or decreased in accordance with an increase or decrease in the number of light sources of the excitation light source 21.

The polarization beam splitter 24 is coated so as to reflect the S-polarized light in the wavelength range of the excitation light P guided from the first optical system 23 and to transmit the P-polarized light in the wavelength range of the excitation light P guided from the first optical system 23 and the fluorescent light Y that is yellow fluorescent light from the phosphor wheel 27. In the example illustrated in FIG. 2, the polarizing beam splitter 24 has a flat plate shape, but a polarizing beam splitter 24 having a prism shape may be used. In the example illustrated in FIG. 2, the polarizing beam splitter 24 reflects the S-polarized light and transmits the P-polarized light in the wavelength range of the excitation light P. In contrast, the P-polarized light may be reflected and the S-polarized light may be transmitted in the wavelength range of the excitation light P.

The quarter-wave plate 25 is disposed so that the optical axis of the quarter-wave plate is tilted by 45 degrees with respect to the linearly polarized light of the excitation light P reflected by the polarizing beam splitter 24. The quarter-wave plate 25 converts linear polarization of the excitation light P reflected by the polarizing beam splitter 24 into circularly polarized light.

The second optical system 26 has a positive power as a whole, and includes a third lens 26A of a positive lens and a fourth lens 26B of a positive lens in order from the excitation light source 21 to the phosphor wheel 27. The excitation light P converted into circularly polarized light from the quarter-wave plate 25 goes in the second optical system 26. The second optical system 26 guides the excitation light P to the phosphor wheel 27 while converging the excitation light P. The excitation light P guided from the second optical system 26 goes in the phosphor wheel 27.

The phosphor wheel 27 corresponds to a wavelength conversion unit that receives the light emitted from the excitation light source 21 and emits the light having a wavelength different from the wavelength of the light emitted from the excitation light source 21. As illustrated in FIGS. 3 and 4, the phosphor wheel 27 includes a disk member 27A and a drive motor 27C that rotates the disk member 27A about a rotation shaft 27B to drive. The disk member 27A may be formed of, for example, a transparent substrate or a metal substrate. However, the disk member 27A is not limited to a transparent substrate and a metal substrate As the metal substrate, for example, an aluminum substrate can be used.

In the phosphor wheel 27, the most part in the circumferential direction is allocated to the phosphor region 27D. In the present embodiment, the phosphor region 27D preferably has an angular range greater than 270 degrees. In the example illustrated in FIG. 3, the phosphor region 27D is 360 degrees. As illustrated in FIG. 4, the phosphor region 27D is formed by laminating a reflective coating 27D1, a phosphor layer 27D2, and an anti-reflective coating 27D3 in order from the lower layer to the upper layer.

The reflective coating 27D1 has a characteristic of reflecting the light in the wavelength range of the fluorescent light Y by the phosphor layer 27D2. When the disk member 27A is formed of a metal substrate having a high reflectance, the reflective coating 27D1 may be omitted. The disk member 27A may also have the function of the reflective coating 27D1.

The phosphor layer 27D2 includes, for example, a layer in which a phosphor material is dispersed in an organic or inorganic binder, a layer in which a crystal of the phosphor material is directly formed, or a layer in which a rare earth phosphor material such as a cerium yttrium aluminum garnet (Ce:YAG) phosphor can be used. As the wavelength range of the fluorescent light Y by the phosphor layer 27D2, for example, yellow and green wavelength ranges can be used. In the present specification, a case where the fluorescent light Y having a yellow wavelength range is used will be described as an example. The wavelength conversion unit is not limited to the phosphor wheel 27, and a phosphorescence material or a nonlinear optical crystal may be used.

The anti-reflective coating 27D3 has a characteristic that prevents reflection of light on the surface of the phosphor layer 27D2.

A reflective coating having a characteristic that reflects light in a wavelength range of the excitation light P guided from the second optical system 26 is laminated in the excitation light reflective region. When the disk member 27A is made of a metal substrate having a high reflectance, the reflective coating may be omitted. The disk member 27A may also have the function of the reflective coating.

The disk member 27A is rotated by the drive motor 27C to drive so that the irradiation position of the excitation light P on the phosphor wheel 27 moves with time. As a result, a portion of the excitation light P that has gone in the phosphor wheel 27 is converted into the fluorescent light Y having a wavelength different from the wavelength range of the excitation light P in the phosphor region 27D (wavelength conversion region), and the phosphor light Y is emitted.

In FIG. 5, most of the light emitted from the phosphor wheel 27 is in the wavelength range of 510 nm or greater and 610 nm or smaller, and is yellow light with high visibility. In addition, since other wavelength ranges other than the wavelength range of 510 nm or greater and 610 nm or smaller is within the visible light range of 428 nm or greater and 688 nm or smaller, the light source 20 can emit light having a good visibility for the projection image.

In FIG. 2, the excitation light P goes in the phosphor region 27D of the phosphor wheel 27 and is converted into the fluorescent light Y, and the phosphor wheel 27 emits the fluorescent light Y. The fluorescent light Y is substantially collimated by the second optical system 26, passes through the quarter-wave plate 25, the polarizing beam splitter 24, and the condenser lens 28, and goes in the light uniformizing element 30.

The fluorescent light Y is guided to the image display element 50 from the light uniformizing element 30 through the illumination optical system 40 to form an image, and is enlarged and projected on the screen 70 by the projection optical system 60. Thus, a monochrome projection image of the fluorescent light Y (yellow) is obtained. In the present embodiment, the case where the yellow phosphor material is used is described as an example, but when the green phosphor material is used as the fluorescent material, a monochrome image of green is obtained. A monochrome image is an image represented by the shading (light and shade) of monochromatic light of a certain spectral distribution. The image display element 50 produces the shading by controlling the brightness at each pixel of the image display element 50.

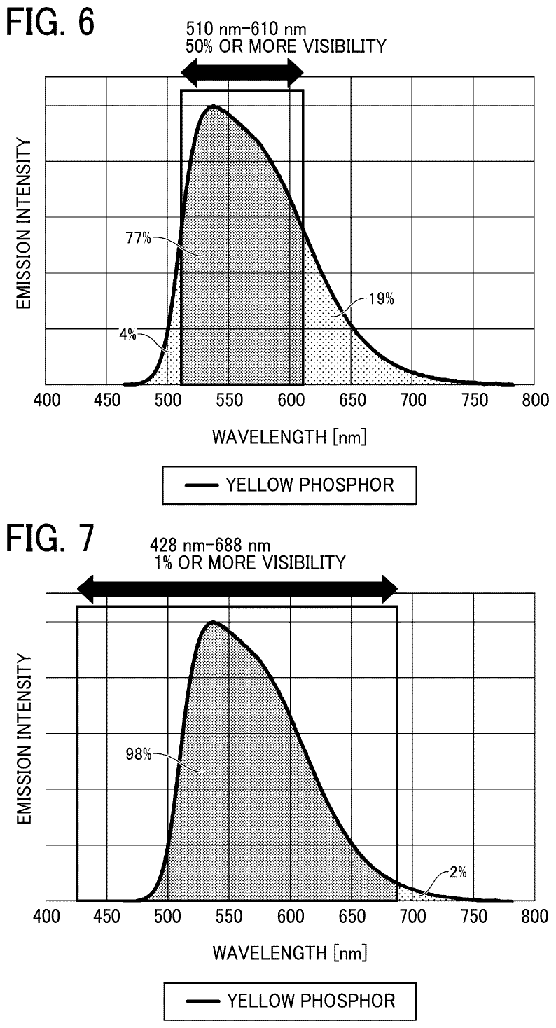

FIG. 6 is a graph of a ratio of an emission intensity of yellow fluorescent light having wavelengths of 510 nm or greater and 610 nm or smaller in a wavelength range of light emitted from the image projection system 1 according to the first embodiment of the present disclosure. FIG. 7 is a graph of a ratio of an emission intensity of yellow fluorescent light having wavelengths of 428 nm or greater and 688 nm or smaller in a wavelength range of light emitted from the image projection system 1 according to the first embodiment of the present disclosure.

A case where a phosphor having a wavelength range from green to yellow is irradiated with blue light emitted from a blue light source to output a fluorescent light Y will be considered. In this case, there are four monochromatic colors of red (R), green (G), black (B), and yellow (Y). A white color is obtained by mixing four single colors, i.e., R, G, B, and Y. For example, the ratio of the four single colors (i.e., monochromatic luminance ratio) is set to R:G:B:Y=0.08:0.3:0.03:0.3 at the time when the white color is output. The difference of 0.29 between the sum of R, G, B, and Y and I is the spoke time. In terms of the amount of luminous flux, when the luminous flux of the image projection system 1 is 5000 lumens, the luminous flux of R is 400 lumens, the luminous flux of G is 1500 lumens, the luminous flux of B is 150 lumens, and the luminous flux of Y is 500 lumens. On the other hand, in terms of the radiation energy ratio, R:G:B:Y=0.10:0.16:0.26:0.17 (and the ratio of the spoke time is 0.30).

When the sum of the radiation energy ratio of R, G, and B (i.e., 0.1+0.16+0.26=0.52) other than Y is all allocated to Y, the amount of luminous flux is increased by 4588 lumens (i.e., 0.52/0.17×1500=4588). In other words, in the image projection system 1, the amount of luminous flux is 1500+4588=6088, and the luminous flux is increased to 6088 lumens.

In the radiation energy ratio, the sum of 0.1 of R and 0.26 of B is 0.36 so that Y obtains 0.36 or more. In addition, when the energy ratios of R and B are doubled, the energy ratios of R and B are 0.2 and 0.52, respectively, which is 0.52 or more of Y. Further, when the radiation energy ratio of the spoke time is allocated to Y, the luminous flux of Y becomes 2647 lumens (i.e., 0.3/0.17×1500=2647). As a result, the amount of luminous flux of Y is 8735 (=6088+2048) lumens, which is about 1.75 times higher than the original luminous flux of 5000 lumens, and the radiation energy ratio is further increased more than twice. When almost all of B is converted into Y, the ratio of Y to B becomes much larger.

In the case of the fluorescent light Y in the present embodiment, as illustrated in FIG. 6, the energy E1 of the wavelength range of 510 nm or greater and 610 nm or smaller is 77%, the energy E2 of the wavelength range smaller than 510 nm is 4%, and the energy E3 of the wavelength range greater than 610 nm is 19%.

Since the relations of E1 (77%)>E2 (4%) and E1 (77%)>E3 (19%) are satisfied, the relation of E1 (77%)>E2 (4%)+E3 (19%) is also satisfied. In other words, “most of the emitted light is green to yellow light having the wavelength range of 510 nm or greater and 610 nm or smaller, which has high visibility. Further, since the relations of E1 (77%)>2×E2 (19%×2) and E1 (77%)>2×E3 (4%×2) are satisfied, the monochromatic light in a more preferable wavelength range can be used.

As illustrated in FIG. 7, since the radiation energy in the wavelength range of 428 nm or greater and 688 nm or smaller, which is the visible light region, is 98% of the total energy of the fluorescent light Y, “the wavelength of the light emitted from the light source is within the wavelength range of the visible light,” and most of the radiation energy is useful for visual recognition. In other words, the fluorescent light Y is efficient for the purpose of providing a brighter and more easily viewable projection image.

### Projection Optical System

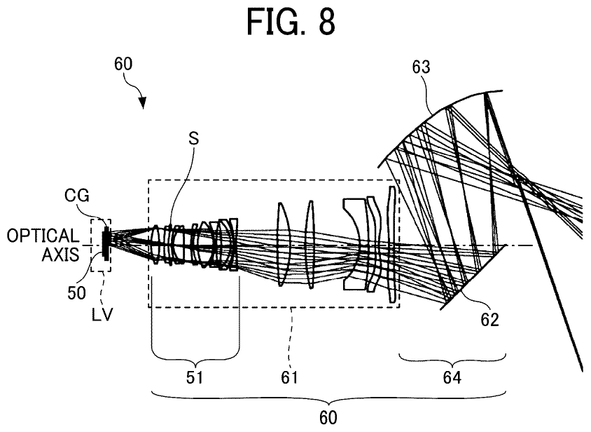

Referring to FIG. 8, a projection optical system 60 included in the image projection system 1 according to the first embodiment of the present disclosure will be described. FIG. 8 is a schematic diagram illustrating the projection optical system 60 included in the image projection system 1 according to the first embodiment of the present disclosure.

FIG. 8 is a diagram illustrating the image display element 50 and the projection optical system 60. The image display element 50 includes an image forming portion LV as a portion that forms an image to be projected. In the image display element 50, the image formed on the image forming portion LV is irradiated with illumination light form the illumination optical system 40.

In the following description, it is assumed that a DMD is used as the image display element 50 that does not have a function to emit light by itself. The projection optical system 60 according to the present embodiment is not limited to this aspect. As the image display element 50, a self-emission type light valve having a function that emits light of a generated image may be used, or a light valve other than the DMD may be used. The projection optical system 60 may further include an illumination device, a mirror, or a dust-proof glass as combinations of them as long as the projection optical system 60 includes the image display element 50 and the projection optical system 60.

As illustrated in FIG. 8, a parallel plate CG is disposed in the vicinity of the image forming portion LV of the image display element 50. The parallel plate CG is a light transmitting plate and is a cover glass (seal glass) of the image forming portion LV. The projection optical system 60 enlarges and projects the image formed on the image forming portion LV on the screen 70 (see FIG. 1), and includes a refractive optical system 61 including multiple lenses 51 and a reflective optical system 64 including a reflective surface having power in order from the image forming portion LV to the screen 70. The multiple lenses 51 include an aperture stop S. The light from the image forming portion LV, which has passed through the parallel plate CG, passes through the multiple lenses 51 and the refractive optical system 61, and is projected on the screen 70 via the reflective optical system 64, including the reflective mirror 62 and the curved mirror 63, in the optical path illustrated FIG. 8.

For example, the reflectance characteristics of the reflective mirror 62 and the curved mirror 63 are designed such that the reflectance is high in the wavelength range of the projection light, so that the image projection system 1 can project a brighter image having a good visibility. It is known that, particularly in the curved mirror 63, the image quality deteriorates due to deformation of the mirror caused by heat generation of the light not reflected. The increase in reflectance can prevent heat generation and provide a more easily viewable projection image.

### Method for Generating Gradation by Image Projection System

A method for generating gradation by the image projection system 1 will be described below.

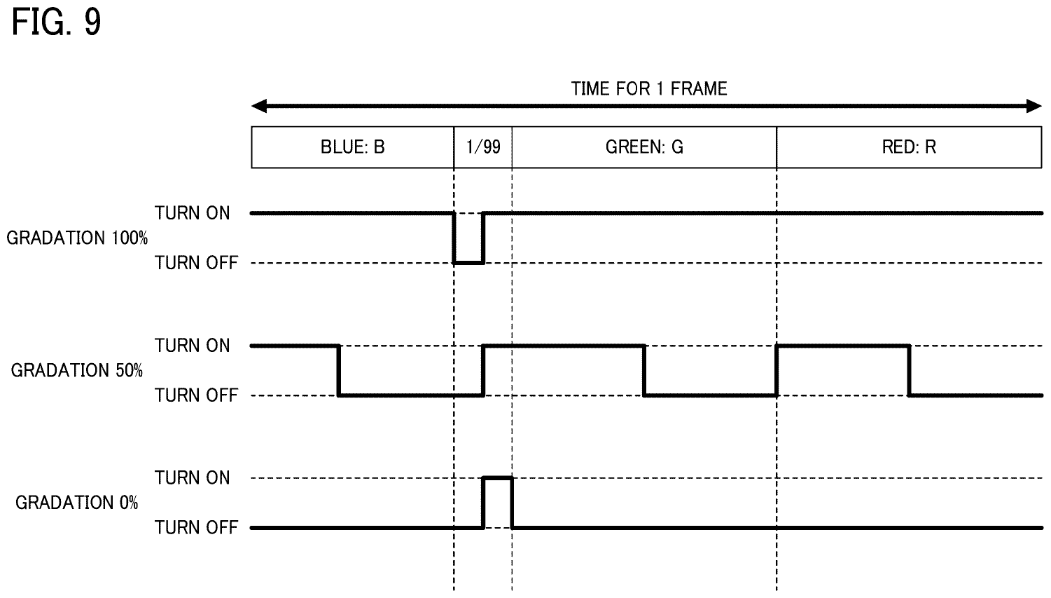

Referring to FIG. 9, first, a method for generating gradation in a typical color-image projection system will be described. FIG. 9 is a timing chart illustrating an example of generation of gradation in a typical color-image projection system. An example of a digital light processing (DLP, registered trademark) projector will be described as a typical color-image projection system. The DLP projector includes a semiconductor device referred to as DMD including multiple micromirrors. The multiple mirrors are arranged in a matrix, and the tilts of the light reflection surfaces of the micromirrors are controllable. The control unit controls the light reflection surface of each micromirror in accordance with the movie signal to tilt so as to switch a light-on state in which the light reflection surface reflects the light to the screen and a light-off state in which the light reflection surface does not reflect the light to the screen while the light reflection surfaces of the micromirrors of the DMD are irradiated with the light from the light source. Accordingly, each micromirror selectively reflects the light from the light source to the screen, and a predetermined image can be projected on the screen. In order to project a color image, a color wheel having three color filters of R, G, and B arranged in a circumferential direction is rotated, and the three color filters of the color wheel are irradiated with the light from the light source such that the light sequentially passes through the three color filters, so that the DMD is irradiated with three colors of the light (i.e., R, G, B).

In the DLP projector, as described above, the control unit controls the tilt of the light reflection surface of each micromirror of the DMD to switch the light-on state and the light-off state (referred to as “ON-and-OFF control” in the following description) in a time-division manner in synchronization with the rotation of the color wheel and the input video signal to reproduce a color of the projection image. In terms of the gradation expression that expresses the color shading in the projection image, a time-division gradation expression is employed. In the time-division gradation expression, the gradation is expressed in a pseudo manner by performing the time division processing of the ON-and-OFF control of each micromirror in accordance with the target image density. The “time-division gradation expression” is, for example, a method for dividing a one-frame output time for outputting one image (i.e., one-frame image) projected on a screen into a light-on time that turns on a micromirror and a light-off time that turns off the micromirror to express gradation by a ratio of the light-on time and the light-off time.

As an example of gradation in a color DLP projector, as illustrated in FIG. 9, at the gradation of 100%, the light is always turned on other than 1/99, and the color becomes white (i.e., the combination of the three primary colors of light, R+G+B, being white). In contrast, at the gradation of 0%, the light is always turned off other than 1/99, and the color of the light is black (i.e., a state in which the light is not substantially applied). At the gradation of 50%, the density of the projection image becomes the intermediate gray density by distributing the first half to the light-on state and the second half to the light-off state in each of the R, G, and B distribution periods in the one-frame output time.

The value of 1/99 indicates that the micromirror is driven by switching the light-on state and the light-off state such that the micromirror does not become fixed and the driving becomes slow when the light continuously hits the micromirror at the gradation of 100%. This switching is performed in such a short time that cannot be visually recognized by human eyes, and does not affect the color of the projected image. In the following description, even in the case where the terms “always light-on” and “always light-off” are used, it is assumed that the light-on and the light-off are slightly generated during the time of 1/99.

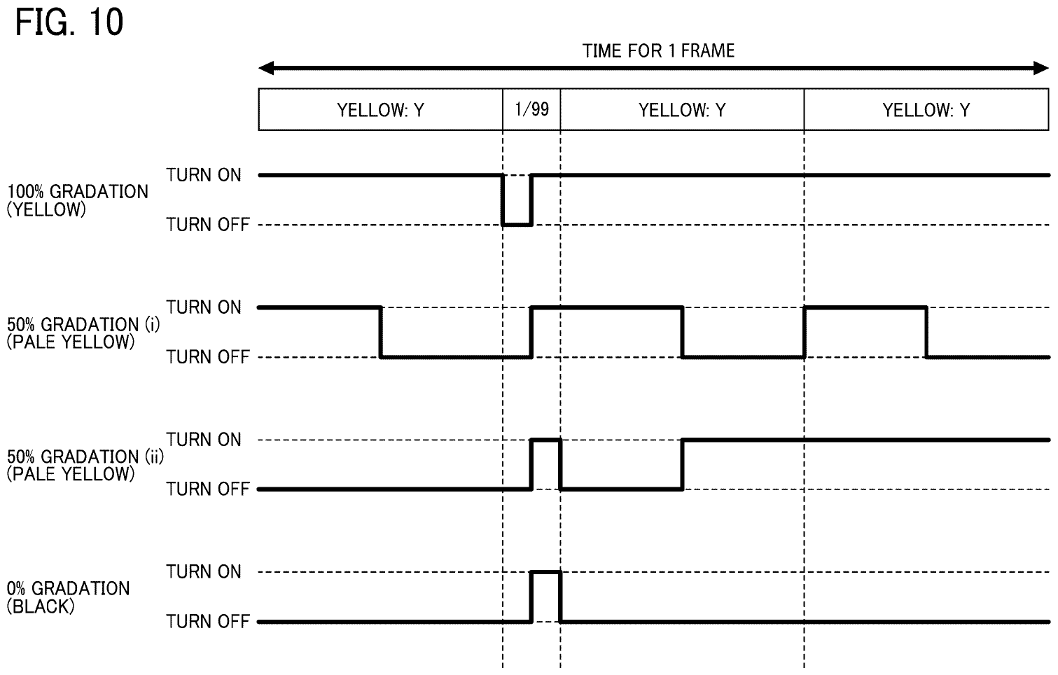

Referring to FIG. 10, a method for generating gradation in the image projection system 1 according to the first embodiment of the present disclosure will be described. FIG. 10 is a timing chart illustrating an example of generation of gradation in the image projection system 1 according to the first embodiment of the present disclosure.

In the image projection system 1, for example, the light from the light source 20 is always yellow. At the gradation of 100%, the color is yellow with the maximum illuminance, at the gradation of 0%, the color is black because the micromirrors are not irradiated with the light other than a short time of 1/99, and at the gradation of 50%, the color is pale yellow (yellow with low illuminance).

Multiple methods for achieving the gradation other than 0% and 100% are conceivable, and at the gradation of 50%, for example, control as illustrated in (i) or (ii) of FIG. 10 is conceivable.

In the case of (i) of the gradation of 50%, the light is turned on for 50% of the first half and the light is turned off for 50% of the second half in each of the three sections divided into RGB in the image projection system 1 so that the light is turned on for 50% of the time and the light is turned off for the remaining 50% of the time per frame time. Similarly, the gradation of 50% can be achieved even when the light-on state and the light-off state are switched for the first half and the second half.

In the case of (ii) of the gradation of 50%, the light is turned on for 50% of the first half and the light is turned off for the second half in one frame time other than the time of 1/99 so that the 50% gradation can be achieved. Similarly, the gradation of 50% can be achieved even when the light-on state and the light-off state are switched for the first half and the second half.

### Processing by Control Unit

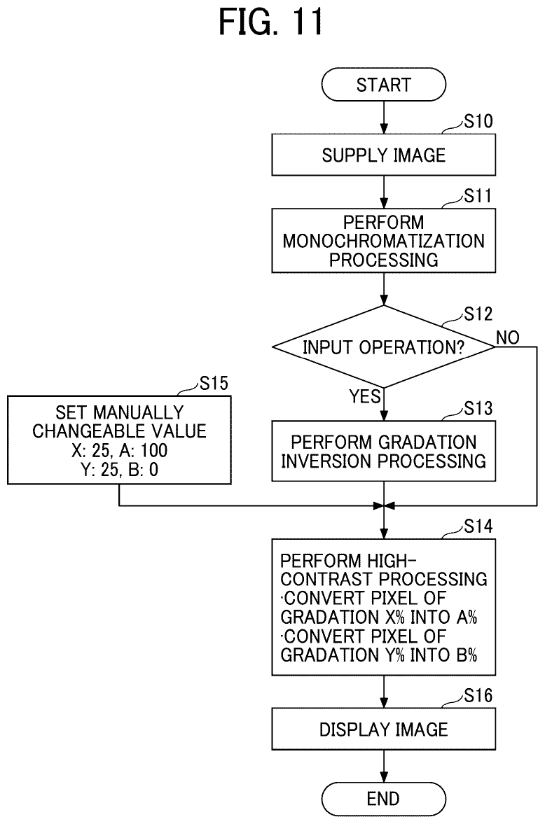

Processing by the control unit 80 will be described with reference to FIG. 11. FIG. 11 is a flowchart of an example of processing performed by the control unit 80 included in the image projection system 1 according to the first embodiment of the present disclosure. The control unit 80 starts the processing of FIG. 11, for example, when an input image is supplied from the video supply device 110.

In step S11, the control unit 80 performs monochrome processing on the input image. The monochrome processing indicates that an image including a multiple-kind (or multiple-color) gradation is converted into a monochromatic (single-color) gradation. For example, when a color image including three color gradations of R, G, and B is converted into an image including a monochromatic gradation, a method for averaging the gradations of R, G, and B (i.e., (R+G+B)/3) may be used, or a method for multiplying R, G, and B by different coefficients (i.e., a×R+b×G+c×B) may be used. The coefficients a, b, and c are typically positive numbers such that a+b+c=1. For example, a=0.3, b=0.6, and c=0.1. However, the values of the coefficients are not limited to these, and the values of the coefficients can be appropriately changed according to applications.

In step S12, the control unit 80 determines whether there is an operation input Tr by the operator U using the operation unit 111 or the infrared remote control 130. In other words, it is determined whether there is command information Ms (i.e., whether the command information Ms has been received). When it is determined in step S12 that there is no operation input Tr (NO in step S12), the control unit 80 proceeds the process to step S14. On the other hand, when it is determined that there is the operation input Tr (YES in step S12), the control unit 80 performs gradation inversion processing that inverts the gradation of at least a partial region of the input image in step S13. The gradation inversion processing is processing in which the gradation of s % is set to the gradation of (100−s) % when the gradation in the state in which the light is always turned on in one frame time is set to 100%. The region in which the gradation inversion processing is performed may be the entire region of the input image, a predetermined partial region of the input image, or a partial region of the input image designated by the operator U through the operation unit 111 or the infrared remote control 130.

In step S14, the control unit 80 performs high-contrast processing on the input image. The input image is either an input image in which the gradation of at least a partial region is inverted by performing the processing of step S13, or an input image in which the gradation is not inverted by not performing the processing of step S13.

The high-contrast processing indicates the processing in which when a pixel has a gradation greater than a first threshold X, the gradation is replaced with a first gradation A and, when a pixel has a gradation less than the second threshold Y, the gradation is replaced with a second gradation less than the first gradation A in the input image in the control unit 80. In the example illustrated in FIG. 11, the first threshold X is 25%, the first gradation A is 100%, the second threshold Y is 25%, and the second gradation B is 0%. For example, in the case of 256 gradations of 8 bits (0- to 255-gradations), 0% indicates 0 in the range of 0-gradation or more and 255-gradation or less. A percentage less than 25% indicates a gradation less than 64-gradation in the range of 0-gradation or more and 255-gradation or less. A percentage more than 25% indicates a gradation of 64-gradation or more in the range of 0-gradation or more and 255-gradation or less. In other words, among 256 gradations, a gradation less than 64-gradation is replaced with 0-gradation, and a gradation of 64-gradation or more is replaced with 255-gradation, resulting in binarization. In terms of an expression using the DMD, an expression by always light-off (0-gradation) and always light-on (255-gradation) indicates a binary expression and has a maximum contrast. Accordingly, characters or lines become easily viewable.

In the input image, the gradation of the pixel higher than the first threshold X is converted into the first gradation A so that characters or lines can be projected in a deep yellow having a higher illuminance. As a result, the contrast ratio between the background and the characters or lines becomes large, and the projection image becomes an easily viewable image with good visibility.

In the input image, the gradation of the pixel lower than the second threshold Y is converted into the second gradation B so that the background can be projected in deep black. As a result, the contrast ratio between the background and the characters or lines becomes large, and the projection image becomes an easily viewable image with good visibility.

In the image projection system 1, in step S15, the first threshold X, the second threshold Y, the first gradation A, and the second gradation B used in the high-contrast processing can be changed by the operator U using the infrared remote control 130 or the operation unit 111.

The first threshold X can be changed in accordance with the operation input Tr by the operator U so that the threshold of the gradation replacement can be changed depending on the situation with respect to the case where the densities of background, characters, and lines are different from each other according to the input image. As a result, the usability of the image projection system 1 can be increased. For example, when a background is not completely white and has color and the background is replaced with the same gradation as characters or lines, the characters or lines may become unviewable. However, since the first threshold can be changed, this can be prevented.

Further, the second threshold Y can be changed in accordance with the operation input Tr by the operator U so that the threshold of the gradation replacement can be changed depending on the situation with respect to the case where the densities of the background, characters, and lines are different from each other according to the input image. As a result, the usability of the image projection system 1 can be increased. For example, changing the second threshold Y can prevent a light-colored character from having the same gradation as the background and being erased.

The input values in the settings of the first threshold X, the second threshold Y, the first gradation A, and the second gradation B may be expressed by other expression methods, such as numerical values corresponding to the number of bits (e.g., in the case of 8 bits, expression of 0-gradation or more and 255-gradation or less) instead of the %-expression. The first threshold X and the second threshold Y may be the same value or different values.

After the high-contrast processing in step S14, the control unit 80 displays an image by the image display element 50 in step S16. The image displayed on the image display element 50 is projected on the screen 70 by the projection optical system 60.

As described above, the image projection system 1 can project an image on a projection surface such as the screen 70 and display the projection image. Even when an image is projected without an operation input and without gradation inversion, gradation inversion can be performed later by the operator U that sends an operation input through the infrared remote control 130 or the operation unit 111. When an image to which the high-contrast processing is not performed is determined to be an easily viewable image by the operator U, the high-contrast processing can be substantially disabled by setting the first threshold X to 100%, the first gradation A to 100%, the second threshold Y to 0%, and the second gradation B to 0%. In the first embodiment of the present disclosure, the image projection system 1 that can be used with a higher degree of freedom for the operator U can be implemented.

The determination in step S12 is not limited to the case where the operation input Tr is received. The image projection system 1 may perform the gradation inversion processing that inverses the gradation of at least a partial region of the input image by inputting the command information Ms when predetermined color code information is set.

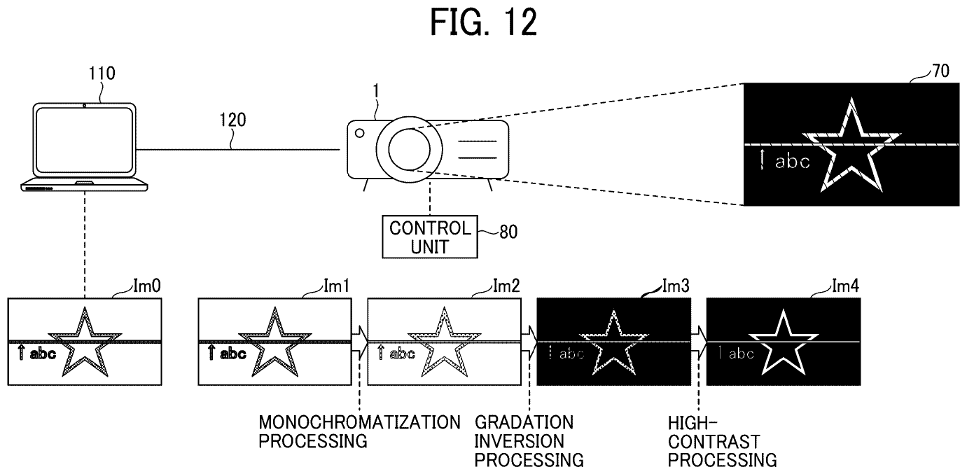

FIG. 12 is a diagram illustrating an example of a series of images obtained by the image projection system 1 according to the first embodiment of the present disclosure. The color image Im0 sent from the video supply device 110 is supplied to the control unit 80 of the image projection system 1 as an input image Im1. The control unit 80 performs monochrome processing on the input image Im1 to convert the input image Im1 into a monochromatic image Im2. The control unit 80 performs the gradation inversion processing in accordance with the operation input Tr of the operator U, and converts the monochromatic image Im2 into a gradation inversion image Im3 in which the positions of the light-on portion and the light-off portion are reversed. The control unit 80 converts the gradation inversion image Im3 into a high-contrast image Im4 in which the light-on portion and the light-off portion are clearly distinguished by the high-contrast processing. The high-contrast image Im4 is displayed on the image display element 50. When an image displayed on the image display element 50 is projected from the image projection system 1 as a yellow monochromatic projection image, a projection image of shading of yellow light, in which a portion of 0-gradation of the projection image is black, is obtained on the screen 70. The white background portion of the color image Im0 is projected as black of 0-gradation with almost no irradiation light in a projection image. In the projection image, a portion in which lines and characters are drawn has the highest illuminance yellow light that the image projection system 1 can output. As a result, the projection image becomes an easily viewable image with clear shading.

### Second Embodiment

An image projection system according to a second embodiment will be described below. The same reference numerals and symbols as those of the above-described embodiments denote the same or similar members or structures, and detailed descriptions thereof will be omitted. This point is also applied to other embodiments described below.

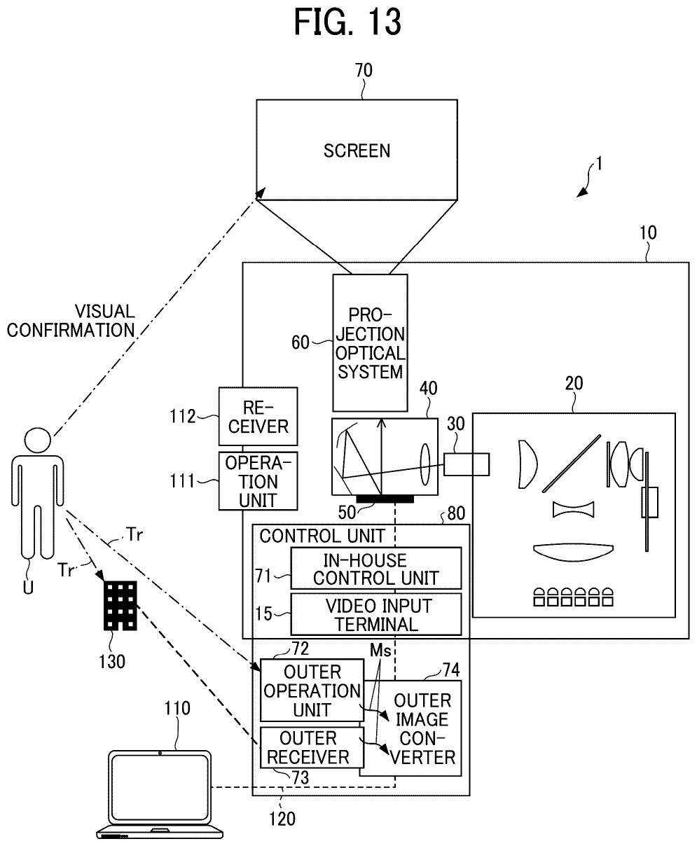

FIG. 13 is a diagram illustrating an example of an overall configuration of an image projection system 1 according to a second embodiment of the present disclosure. In FIG. 13, the inside of the image projection system 1 is illustrated as a perspective view.

The second embodiment of the present disclosure is mainly different from the first embodiment of the present disclosure in that the range of the control unit 80 extends to the inside and outside of the housing 10.

The control unit 80 illustrated in FIG. 13 includes an in-house control unit 71 and a video input terminal 15. An outer image converter 74 is disposed between the video supply device 110 and the video input terminal 15. The video supply device 110 and the outer image converter 74 are electrically connected to each other by a cable 120. The outer image converter 74 and the video input terminal 15 are electrically connected to each other by a cable 120. The outer image converter 74 performs at least a part of the image processing such as the gradation inversion processing (step S13) or the high-contrast processing (step S14) in the flowchart illustrated in FIG. 11.

The outer image converter 74 includes an outer operation unit 72 and an outer receiver 73. When the outer operation unit 72 is operated by the operator U or operated with the infrared remote control 130 by the operator U, a signal is sent to the outer receiver 73. In response to the operation input Tr from the outer operation unit 72 or the outer receiver 73, the command information Ms corresponding to the operation input Tr is output from the outer operation unit 72 or the outer receiver 73 to the outer image converter 74. Accordingly, the image processing is performed by the control unit 80 inside and outside the housing 10, such as the outer image converter 74.

In the second embodiment of the present disclosure, the outer image converter 74 is externally added to an image projection apparatus that does not have an image processing function to add the image processing function so that the image projection system 1 is configured. As a result, the image projection system 1 can perform the image processing such as the gradation inversion processing or the high-contrast processing. Thus, the application range of the image projection system 1 can be extended. The outer image converter 74 can be implemented by, for example, a relay board. The outer image converter 74 may be integrated with the cable 120 as one body or may be separate from the cable 120. Effects of the second embodiment other than the above are the same as those of the first embodiment.

### Third Embodiment

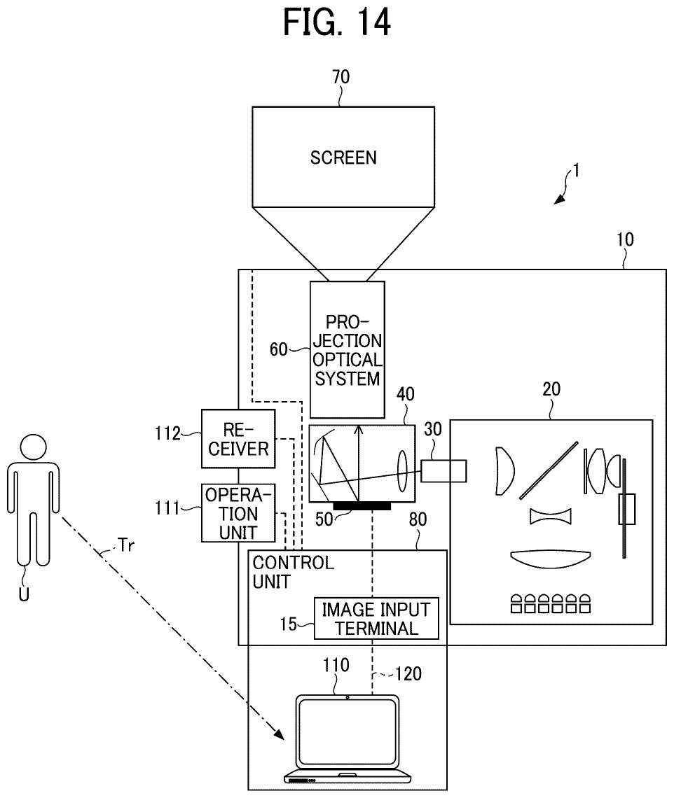

An image projection system according to a third embodiment will be described below. FIG. 14 is a diagram illustrating an example of an overall configuration of an image projection system 1 according to a third embodiment of the present disclosure. In FIG. 14, the inside of the image projection system 1 is illustrated as a perspective view.

The third embodiment of the present disclosure is mainly different from the first embodiment of the present disclosure in that the control unit 80 includes the video supply device 110.

In the example illustrated in FIG. 14, the video supply device 110 selects a color image that is an original image to be projected on the screen 70 in accordance with the operation input Tr of the operator U. The video supply device 110 performs at least a part of the image processing such as the gradation inversion processing (step S13) or the high-contrast processing (step S14) in the flowchart illustrated in FIG. 11 in accordance with the operation input Tr of the operator U.

In the third embodiment of the present disclosure, the image projection system 1 is configured by combining an image projection apparatus that does not have an image processing function and a video supply device 110 that has an image processing function so that image processing such as gradation inversion processing or high-contrast processing can be performed. Thus, the application range of the image projection system 1 can be extended. When the video supply device 110 is a personal computer, a tablet, or a smartphone, the video supply device 110 may start image processing in response to an operation input Tr of the operator U using a dedicated application program. Effects of the third embodiment other than the above are the same as those of the first embodiment.

### Fourth Embodiment

An image projection system according to a fourth embodiment will be described below. The fourth embodiment of the present disclosure differs from the first embodiment of the present disclosure mainly in that when the average picture level (APL) of an input image is obtained and the APL of the input image is higher than a predetermined APL threshold, command information Ms arises, and at least a partial region of the input image is inverted by using the command information Ms as a trigger.

FIG. 15 is a flowchart of an example of processing performed by the control unit 80 included in the image projection system 1 according to the fourth embodiment of the present disclosure. The control unit 80 starts the processing illustrated in FIG. 15, for example, when an input image is supplied from the video supply device 110. In the description of FIG. 15, the description of the same processing as the processing illustrated in FIG. 11 is omitted, and the differences will be mainly described.

In step S22, the control unit 80 calculates the APL of the input image and determines whether the APL of the input image is higher than a predetermined APL threshold. In other words, it is determined whether there is command information Ms (i.e., whether the command information Ms has been received).

In step S22, when the APL of the input image is determined not to be higher than a predetermined APL threshold (NO in step S22), the control unit 80 shifts the processing to step S25. On the other hand, when the APL of the input image is determined to be higher than the predetermined APL threshold (YES in step S22), the control unit 80 performs gradation inversion processing that inverts the gradation of at least a partial region of the input image in step S23. In step S24, the control unit 80 can change the APL threshold in accordance with the operation input Tr of the operator U through the operation unit 111 or the infrared remote control 130.

In the image projection system 1 according to the fourth embodiment of the present disclosure, the control unit 80 performs the gradation inversion processing when the APL of the input image is higher than the APL threshold so that the input image requiring the gradation inversion processing can be automatically subjected to the gradation inversion without the operation of the operator U such as a user. Thus, an easily viewable projection image can be obtained without taking much time and effort of the operator U. When the projection image is not likely to be an easily viewable image in the case where the background of the input image is white in a bright place, the automatic gradation inversion allows the projection image to be easily viewable. An image that requires the gradation inversion processing is typically an image having a white background (or a background of a light color close to white). Such an image typically has a high APL. For example, when the APL of the input image is higher than 50% and the APL threshold is set to 50%, the gradation inversion processing is performed without the operation of the operator U. The automatic gradation inversion is performed using the APL threshold in the initial output immediately after the image is input. However, when the projection image subjected to the automatic gradation inversion is determined to become a more easily viewable image by cancellation of the automatic gradation inversion based on visual inspection of the operator U, the gradation inversion can be cancelled according to an operation input Tr of the user U after the automatic gradation inversion.

In the image projection system 1, the control unit 80 can change the image average luminance threshold in accordance with the operation input Tr of an operator U. Accordingly, a condition that causes a not-easily viewable image can be more accurately defined. When a projection image is likely to be a not-easily viewable image, the gradation inversion can be applied to the projection image based on the condition with high reliability to obtain an easily viewable projection image.

In the example illustrated in FIG. 15, the set values of the high-contrast processing are different from the set values illustrated in FIG. 11. In the example illustrated in FIG. 15, in terms of the set values of the high-contrast processing, the first threshold X is set to 30, the first gradation A is set to 100, the second threshold Y is set to 20, and the second gradation B is set to 0. Accordingly, in the high-contrast processing, when the gradation of a pixel is 30% or more, the gradation is replaced with 100%, and when the gradation of a pixel is less than 20%, the gradation is replaced with 0%. In this case, unlike the binarization processing in the first embodiment illustrated in FIG. 11, the fine gradation of the boundary can be output as it is without the gradation replacement, and a line of a light color close to the background color can be left in the display image. This processing is convenient when an image of a drawing including auxiliary lines is projected, and an easily viewable and recognizable image can be projected.

Effects of the third embodiment other than the above are the same as those of the first embodiment.

Although some preferable embodiments have been described in detail, the present disclosure is not limited to the above-described embodiments, and various modifications and substitutions can be made to the above-described embodiments without departing from the scope of the claims.

All the numerals such as ordinal numbers and numbers used in the description of the embodiments are illustrative for specifically describing the technique of the present disclosure, and the present disclosure is not limited to the illustrated numerals. In addition, a coupling relation between the components is an example for specifically describing the technology of the present disclosure, and a connection relation for implementing a function of the present disclosure is not limited thereto.

Some application examples of the image projection system according to embodiments of the present disclosure will be described below.

### Head-Mounted Display Apparatus

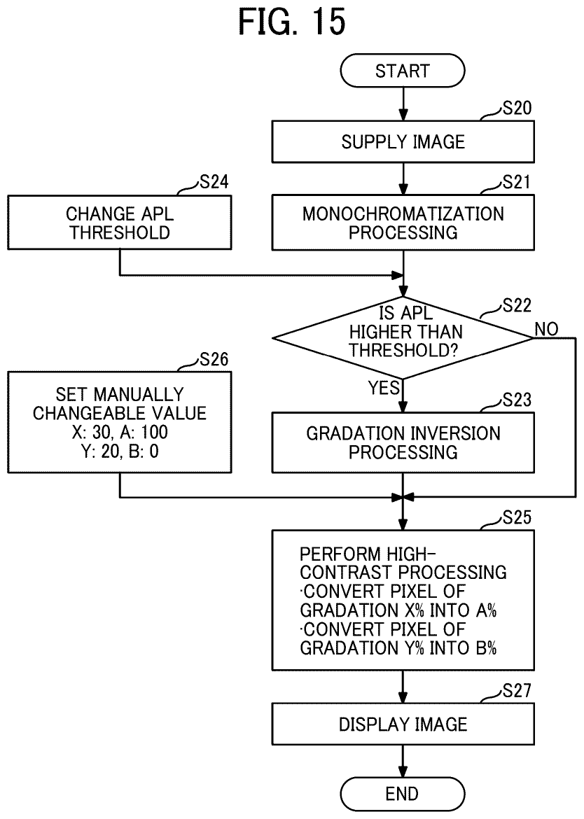

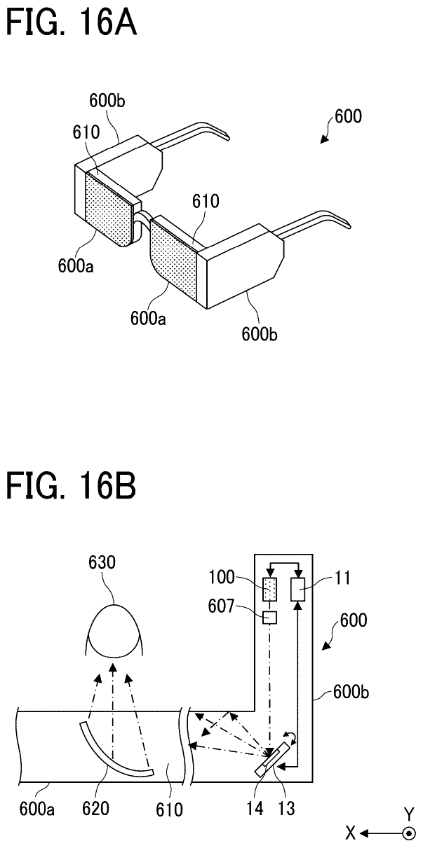

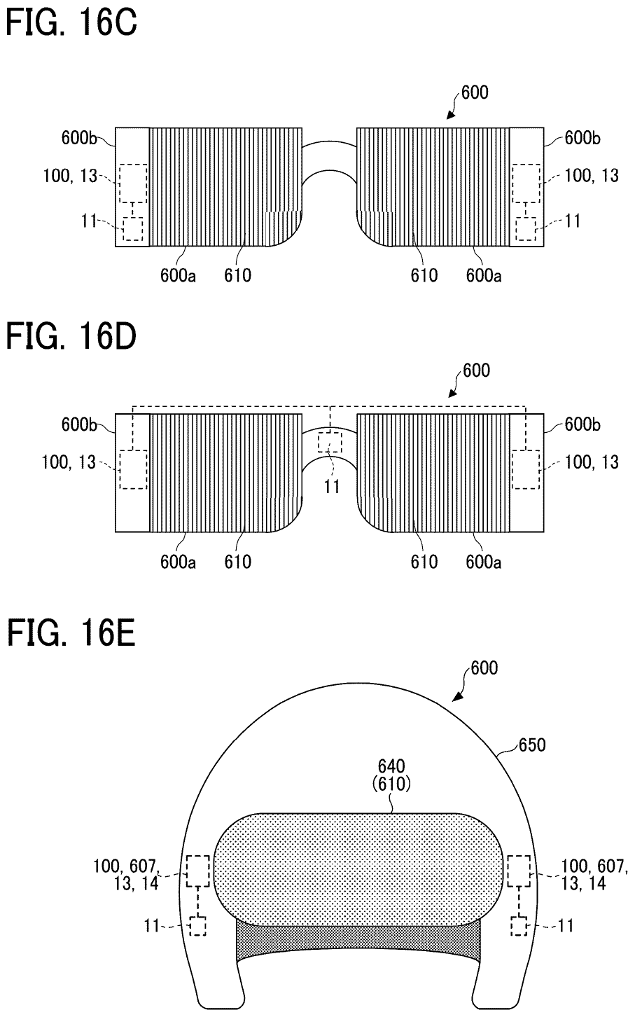

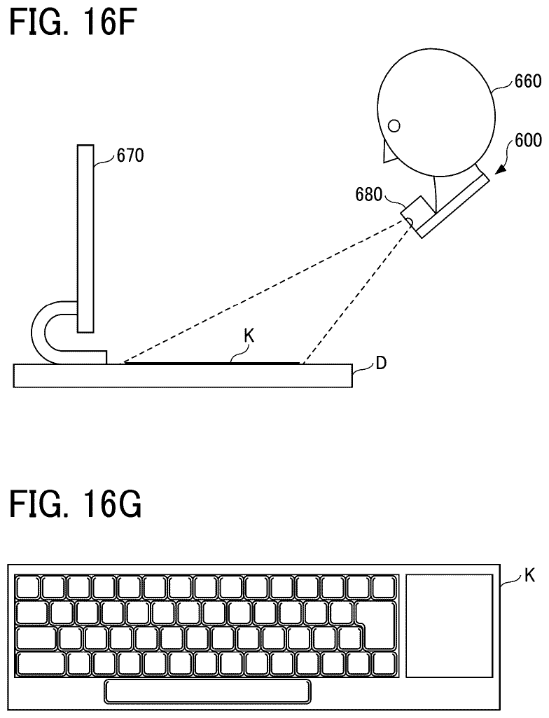

FIG. 16A is a schematic perspective view of a configuration of a wearable display apparatus 600 that is an example of a projection apparatus. FIG. 16B is a schematic diagram illustrating a part of the wearable display apparatus 600 illustrated in FIG. 16A.

The illustrated wearable display apparatus 600 is a head-mounted display that can be mounted on the human head, and includes, for example, a head-mounted display device having a shape similar to glasses or goggles. In FIG. 16A, the wearable display apparatus 600 includes fronts 600a and temples 600b that are disposed in a substantially symmetrical manner in pairs on the left and right sides. The fronts 600a may include, for example, the light guide plates 610, and the optical systems and the control devices can be built in the temples 600b.

FIG. 16B is a schematic diagram illustrating a partial configuration of the wearable display apparatus 600. Although FIG. 16B illustrates the configuration for the left eye, the wearable display apparatus 600 has a similar configuration for the right eye.

The wearable display apparatus 600 includes, for example, a control device 11, a light source 100 that is a light source device according to the present embodiment, a light amount adjusting unit 607, a movable device 13 including a reflective surface 14, a light guide plate 610, and a half mirror 620.

The light source 100 is a unit in which a laser light source, a collimator lens, and a dichroic mirror are formed as a unit by an optical housing.

The light from the light source 100 is adjusted by the light amount adjusting unit 607 in its amount of the light and goes in the movable device 13. The movable device 13 moves the reflective surface 14 in the X- and Y-directions based on the signal from the control device 11, and two-dimensionally scans the inner wall of the light guide plate 610 with the light from the light source 100. The control device 11 controls the movable device 13 to drive in synchronization with, for example, the timing of emission of a laser light source disposed in the light source 100.

The scan light by the movable device 13 goes in the light guide plate 610. The light guide plate 610 guides the scan light to the half mirror 620 while reflecting the scan light on the inner wall surfaces. The light guide plate 610 is made of a resin having a transparency with respect to the wavelength of the scan light.

The half mirror 620 reflects the light from the light guide plate 610 to the back side of the wearable display apparatus 600 and emits the light toward the eye 630 of the wearer of the wearable display apparatus 600. The half mirror 620 has, for example, a free-form surface shape. The image by the scan light is reflected by the half mirror 620 and is formed on the retina of the wearer 630. Alternatively, the image is formed on the retina of the wearer 630 by the reflection at the half mirror 620 and the lens effect of the lens of the eyeball. The spatial distortion of the image is corrected by the reflection at the half mirror 620. The image formed by scanning the retina with the light in the X- and Y-directions can be observed by the wearer. Since the half mirror 620 is used, an image formed by the light from the outside and an image formed by the scan light are superimposed. As a result, a superimposed image can be observed by the wearer. A mirror may be used instead of the half mirror 620 so that the light from the outside is eliminated, and only an image formed by the scan light can be observed.

FIG. 16C is a schematic diagram illustrating an example of another configuration of a wearable display apparatus 600. As illustrated in FIG. 16C, the control devices 11 included in the wearable display apparatus 600 are disposed in the left and right temples 600b so as to correspond to the light sources 100 and the movable devices 13 built in the left and right temples 600b.

As illustrated in FIG. 16D, the control device 11 may be disposed at the intermediate position of the left and right light guide plates 610 of the wearable display apparatus 600, and controls the light sources 100 and movable devices 13 built in the left and right temples 600b.

Further, the wearable display apparatus 600 may be in the form of a helmet 650 having a visor 640 including a light guide plate 610 as illustrated in FIG. 16E. In this case, the light sources 100, the light amount adjusting units 607, the movable devices 13, the reflective surface 14, and the control devices 11 may be built in the helmet 650 as illustrated in FIG. 16E.

FIG. 16F is a schematic diagram illustrating an example of another configuration of a wearable display apparatus 600. The illustrated wearable display apparatus 600 is a neckband type display apparatus that can be worn on the neck or shoulder of a person.

In FIG. 16F, a wearer 660 wearing a wearable display apparatus 600 is sitting in front of a display 670 placed on a desk D. The display 670 communicates with the wearable display apparatus 600 through short-range wireless communication such as Bluetooth, and outputs a display signal. The wearable display apparatus 600 includes a projector 680, and the projector 680 projects an image K of an input keyboard as illustrated in FIG. 16G on the upper surface of the desk D.

The wearable display apparatus 600 may include a camera in addition to the projector 680. The camera detects the movement of the fingers of wearer 660 on the image K for the input keyboard projected on the desk D. The information on the detection result of the camera is transmitted to, for example, the control device of the wearable display apparatus 600, and the control device determines which key of the input keyboard is pressed by the wearer 660 based on the information received from the camera, and displays the information corresponding to the determination result on the display 670.

### Head-Up Display Apparatus

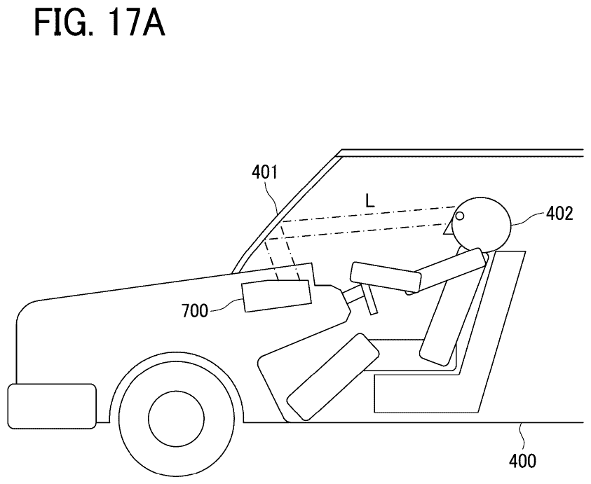

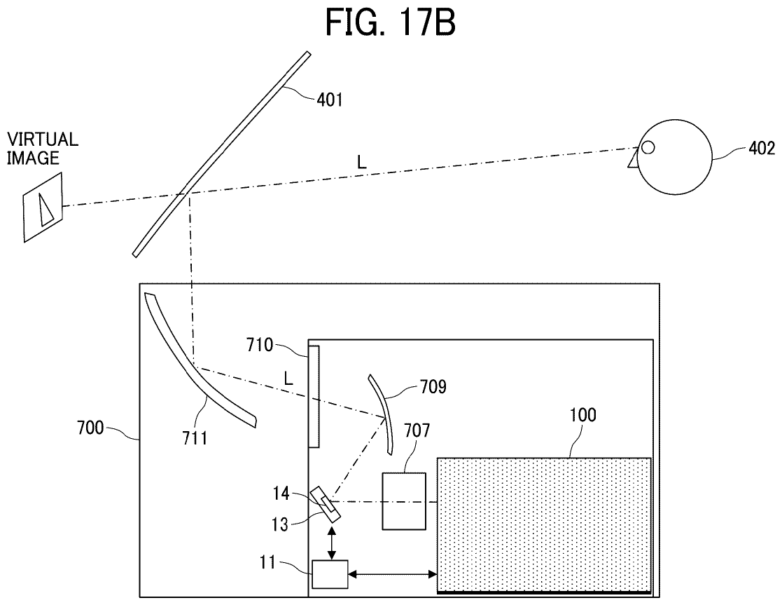

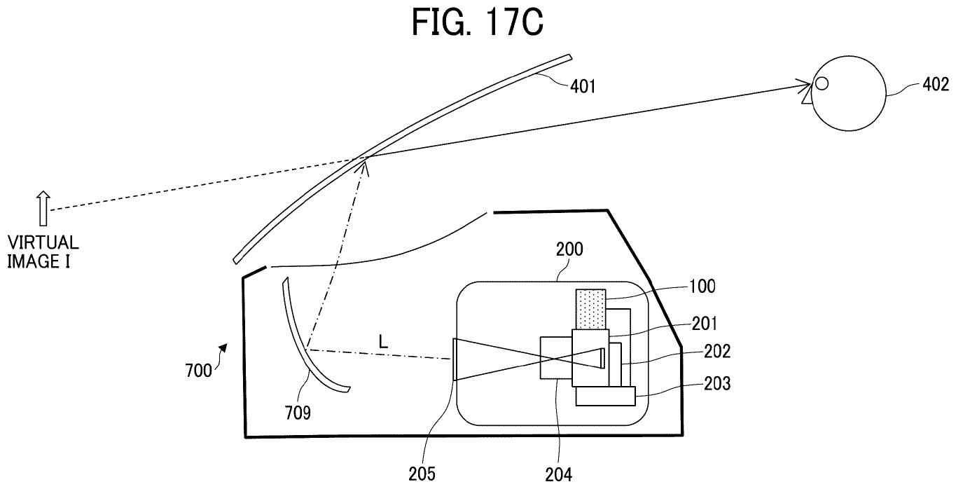

FIG. 17A is a schematic diagram illustrating an example of an automobile 400 that installs a head-up display apparatus 700 that is an example of a projection apparatus, and FIG. 17B is a schematic diagram illustrating an example of a head-up display apparatus 700. The head-up display apparatus 700 is, for example, a projection apparatus that projects an image by performing optical scan.

As illustrated in FIG. 17A, the head-up display apparatus 700 is disposed, for example, near a windshield 401 of an automobile 400. The projection light L emitted from the head-up display apparatus 700 is reflected by the windshield 401 and directed to a driver 402 (observer) that is a user. Accordingly, the driver 402 can visually recognize the image projected by the head-up display apparatus 700 as a virtual image. Another configuration in which a combiner is disposed on an inner wall surface of the windshield so that a virtual image formed by the projection light reflected by the combiner can be visually recognized by a user may be used.

As illustrated in FIG. 17B, the head-up display apparatus 700 includes the light source 100 that is a light source device according to the present embodiment. The light emitted from the light source 100 passes through, for example, the light amount adjusting unit 707, and is deflected by the movable device 13 including the reflective surface 14. The deflected light is projected on a screen through a projection optical system including a free-form surface mirror 709, an intermediate screen 710, and a projection mirror 711.

The head-up display apparatus 700 described above projects an intermediate image displayed on the intermediate screen 710 on the windshield 401 of the automobile 400 so that the intermediate image is visually recognized by the driver 402 as a virtual image.

The amount of the light emitted from the light source 100 is adjusted by the light amount adjusting unit 707, and the movable device 13 including the reflective surface 14 two-dimensionally scans the free-form surface mirror 709 with the laser light. The projection light L with which the movable device 13 two-dimensionally scans the free-form surface mirror 709 is reflected by the free-form surface mirror 709 is corrected in distortion, and is condensed on the intermediate screen 710 to display an intermediate image. The intermediate screen 710 includes a microlens array in which microlenses are two-dimensionally arranged, and enlarges the projection light L incident on the intermediate screen 710 at each microlens.

The movable device 13 reciprocates the reflective surface 14 in two-axial directions and two-dimensionally scans the free-form surface mirror 509 with the projection light that goes in the reflective surface 14. The control device 11 controls the movable device 13 to drive in synchronization with, for example, the timing of emission of a laser light source disposed in the light source 100.

As illustrated in FIG. 17C, the head-up display apparatus 700 includes an imager 200 and a free-form surface mirror 709. Among them, the imager 200 includes the light source 100 according to the present embodiment.

For example, the image forming unit 202 is irradiated with the light emitted from the light source 100 and passed through the illumination optical system 201. The image forming unit 202 includes a light modulating unit such as a micromirror device or a liquid crystal panel. The control device 203 controls the light emission drive of the light source included in the light source 100 and the drive of the light modulation unit included in the image forming unit 202. The image generated by the image forming unit 202 is used to form an intermediate image on an intermediate screen 205 by a projection lens 204.

The head-up display apparatus 700 reflects the image formed on the intermediate screen 205 to the windshield 401 of the automobile via the free-form surface mirror 709, and allows the driver 402 to visually recognize the virtual image I. A folding mirror may be disposed between the free-form surface mirror 709 and the windshield 401 as required for layout reasons.

The intermediate screen 205 includes, for example, a microlens array in which microlenses are two-dimensionally arranged. In the present embodiment, the microlens array is used to control the viewing angle characteristic so that the viewing angle characteristic of the image projected on the intermediate screen 205 is enhanced. As a result, a brighter virtual image is produced.

The projection apparatus is not limited to the configurations of the projector, the wearable display apparatus, and the head-up display apparatus described above. The projection apparatus is not limited to being mounted on a vehicle or a human body, and may be mounted on, for example, a railway vehicle, an aircraft, or a ship. The projection apparatus may be mounted on a moving body such as a robot that can perform autonomous movement or remote control movement, a drone, an unmanned aerial vehicle, or a non-moving body such as a work robot that operates a moving object such as a manipulator without moving from the site.

Aspects of the present disclosure are, for example, as follows.

### First Aspect

An image projection system includes a light source, an image display element that displays an image by modulating light from the light source in accordance with an input image, a projection optical system that projects the image displayed by the image display element, and a control unit that inverts a gradation of at least a partial region of the input image in response to a receipt of command information generated when a predetermined condition is satisfied.

### Second Aspect

In the image projection system according to the first aspect, the control unit determines whether to start processing that inverts the gradation of at least the partial region of the input image in accordance with an operation input by an operator, and inverts the gradation of at least the partial region of the input image in accordance with a result of the determination.

### Third Aspect

In the image projection system according to the first or second aspect, the control unit can change an image average luminance threshold in accordance with an operation input by an operator.

### Fourth Aspect

In the image projection system according to any one of the first to third aspects, the input image is a color image, and the control unit performs monochrome processing on the input image.

### Fifth Aspect

In the image projection system according to any one of the first to fourth aspects, the control unit converts a gradation of a pixel in the input image into a first gradation when the gradation of the pixel is higher than a first threshold.

### Sixth Aspect

In the image projection system according to the fifth aspect, the control unit can change the first threshold in accordance with an operation input by an operator.

### Seventh Aspect

In the image projection system according to fifth aspect, the control unit converts the gradation of the pixel in the input image into a second gradation when the gradation of the pixel is lower than a second threshold lower than the first gradation.

### Eighth Aspect

In the image projection system according to the seventh aspect, the control unit can change the second threshold in accordance with an operation input by an operator.

### Ninth Aspect

In the image projection system according to any one of the first to eighth aspects, the light emitted from the light source satisfies A>B and A>C, where A is a radiation energy of light having a wavelength of 510 nm or greater and 610 nm or smaller, B is a radiation energy of light having a wavelength of smaller than 510 nm, and C is a radiation energy of light having a wavelength of greater than 610 nm, and the image projected by the projection optical system also satisfies A>B and A>C.

### Tenth Aspect

In the image projection system according to the ninth aspect, light emitted from the light source emits light satisfying A>B+C.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. An image projection system comprising:
a light source to emit light;
an image display element to modulate the light emitted from the light source to display an image based on an input image;
a projection optical system configured to project the image displayed on the image display element; and
circuitry configured to inverse gradation of at least a partial region of the input image in response to a receipt of a command information generated when a predetermined condition is satisfied.

2. The image projection system according to claim 1,
wherein the circuitry is further configured to:
determine whether to start inversing gradation of the at least the partial region in response to a receipt of an operation input; and
inverse the gradation of the at least the partial region based on a determination of starting the inversing gradation.

3. The image projection system according to claim 1,
wherein the circuitry is further configured to change a threshold of an average brightness of the image displayed on the image display element according to an operation input.

4. The image projection system according to claim 1,
wherein the circuitry is further configured to convert the input image having multiple-color gradation into a monochromatic gradation to perform monochrome processing.

5. The image projection system according to claim 1,
wherein the circuitry is further configured to convert a gradation of a pixel higher than a first threshold in the input image into a first gradation higher than the first threshold.

6. The image projection system according to claim 5,
wherein the circuitry is configured to change the first threshold according to an operation input.

7. The image projection system according to claim 5,
wherein the circuitry is configured to convert a gradation of a pixel lower than a second threshold into a second gradation lower than the first gradation, and the second threshold is equal to or lower than the first threshold.

8. The image projection system according to claim 7,
wherein the circuitry is configured to change the second threshold according to an input operation.

9. The image projection system according to claim 1,
wherein the light source emits first light, second light, and third light satisfying:
A>B and A>C,
where A is radiation energy of the first light having wavelength of 510 nm or greater and 610 nm or smaller,
B is radiation energy of the second light having wavelength smaller than 510 nm, and
C is radiation energy of the third light having wavelength greater than 610 nm, and the image projected by the projection optical system satisfies: A>B and A>C.

10. The image projection system according to claim 9,
wherein the light source emits the first light, the second light, and third light satisfying:
A>B+C.
